(19) United States
(12) Patent Application Publication
(10) Pub. No.: US 2025/0285527 A1
(43) Pub. Date: Sep. 11, 2025

(54) ELECTROSTATIC DISCHARGE CONTROL DEVICE ALERT SYSTEMS AND METHODS

(71) Applicant: DISH Network Technologies India Private Limited, Bengaluru (IN)

(72) Inventors: Mansoor Ahmed, Bangalore (IN); Kommireddy Vinay Kumar Reddy, Andhra Pradesh (IN); Naveen Pendyala, Hyderabad (IN); Yashwanth B. Melwanki, Bengaluru (IN)

(21) Appl. No.: 18/597,754

(22) Filed: Mar. 6, 2024

(51) Int. Cl. G08B 21/24; G08B 21/22

(52) U.S. Cl. CPC G08B 21/24; G08B 21/22

(57) ABSTRACT

An ESD control device alert system may comprise a first sensor configured to detect a person entering an area designated for ESD control (e.g., an ESD sensitive area); a second sensor configured to detect whether a person in the area is wearing an ESD control device; a control system coupled to the first sensor and second sensor configured to determine whether to activate or deactivate an alert to wear an ESD control device based on the detection whether a person in the area is wearing an ESD control device; and an alert system coupled to the control system configured to activate and deactivate the alert in response to input from the control system. Input from the control system may be a power signal providing power to the alert system received by the control system via the first sensor.

### BRIEF SUMMARY

Electrostatic discharge (ESD) is the rapid, spontaneous transfer of electrostatic charge induced by a high electrostatic field. Usually, the charge flows through a spark between two conductive bodies at different electrostatic potentials as they approach one another. ESD can change the electrical characteristics of a semiconductor device, degrading or destroying it. ESD may also upset the normal operation of an electronic system, causing equipment malfunction or failure. Electrostatically charged surfaces can attract and hold contaminants, making removal of the particles difficult. When attracted to the surface of a silicon wafer or a device's electrical circuitry, air-borne particulates can cause random wafer defects and reduce product yields.

ESD impacts productivity and product reliability in virtually every aspect of the global electronics environment. ESD affects production yields, manufacturing cost, product quality, product reliability, and profitability. The cost of damaged devices ranges from only a few cents for a simple diode to thousands of dollars for complex integrated circuits. When associated costs of repair and rework, shipping, labor, and overhead are included, there is a need for significant improvements to control ESD. As electronic devices become faster and the circuitry gets smaller, sensitivity to ESD in general increases. Thus, with devices becoming more sensitive, it is also important that companies improve their ESD control capabilities and processes.

To help address such issues, ESD control devices may be worn by a person testing or working on electronic devices to discharge the static being generated on the body to ground instantly and protect the electronics. Example of ESD devices include, but are not limited to: ESD control wrist straps, an ESD control gloves, an ESD control garments, ESD control clothing, ESD control footwear, and ESD control slippers. However, people may sometimes forget to wear such devices when working on or testing electronic devices. Thus, it would be beneficial to have a helpful reminder to do so when a person enters an ESD sensitive area designated for ESD control and they have forgotten to bring or have not yet put on the ESD control device (e.g., when entering a room with an ESD sensitive area and/or sitting at a electronics hardware laboratory work bench area or work station).

In order to solve the above technical problems, an ESD control device alert system is disclosed herein. The system may comprise: a first sensor configured to detect a person entering an area designated for ESD control; a second sensor configured to detect whether a person in the area is wearing an ESD control device; a control system coupled to the first sensor and second sensor configured to determine whether to activate or deactivate an alert to wear an ESD control device based on the detection whether a person in the area is wearing an ESD control device; and an alert system coupled to the control system configured to activate and deactivate the alert in response to input from the control system.

A method in such an ESD control device alert system may comprise: detecting, via a first sensor device, a person entering an area designated for ESD control; detecting, via a second sensor device, whether a person in the area is wearing an ESD control device; electronically determining whether to activate or deactivate an alert to wear an ESD control device based on the detection whether a person in the area is wearing an ESD control device; and activating or deactivating the alert based on the determination.

For example, the system may detect, via a passive infrared (PIR) sensor (e.g., positioned underneath an electronics work bench), a person entering an area designated for ESD control. In response to detecting the person is entering the area designated for ESD control, the system may then detect, via a capacitive touch switch attached to the ESD control device that detects contact with the person's skin, whether the person in the area is wearing the ESD control device (e.g., an ESD control wrist strap or footwear). The alert is then activated (e.g., a sign on the work bench is illuminated) in response to a determination the person in the area is not wearing an ESD control device. When the person then puts on the ESD control device, the capacitive touch switch will detect the person is wearing the device and the alert is then deactivated in response.

When the person leaves the area, the system may then detect, via the PIR sensor, that there is no longer a person in the area designated for wearing an ESD control device. In response, the system may deactivate any current activation of the alert, such as, for example, by deactivating operation of the capacitive touch sensor that detects whether a person in the area is wearing an ESD control device.

### BRIEF DESCRIPTION OF THE DRAWINGS

FIG. 1 is a block diagram of an electrostatic discharge (ESD) control device alert system according to one non-limiting embodiment.

FIG. 2 is perspective view of a person sitting at an electronics work bench at which the ESD control device alert system of FIG. 1 has activated an alert, according to one non-limiting embodiment.

FIG. 3 is perspective view of the person sitting at the electronics work bench of FIG. 2 at which the ESD control device alert system of FIG. 1 has deactivated an alert, according to one non-limiting embodiment.

FIG. 4 is top perspective view of a person entering an area designated for ESD control in which an ESD control device alert system has activated an alert, according to one non-limiting embodiment.

FIG. 5 is a flow diagram of an example method in an ESD control device alert system, according to one non-limiting embodiment.

FIG. 6 is a flow diagram of an example method in an ESD control device alert system for when there is no longer a person detected in the ESD control area, according to one non-limiting embodiment.

FIG. 7 is a flow diagram of an example method in an ESD control device alert system involving an RFID reader, according to one non-limiting embodiment.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

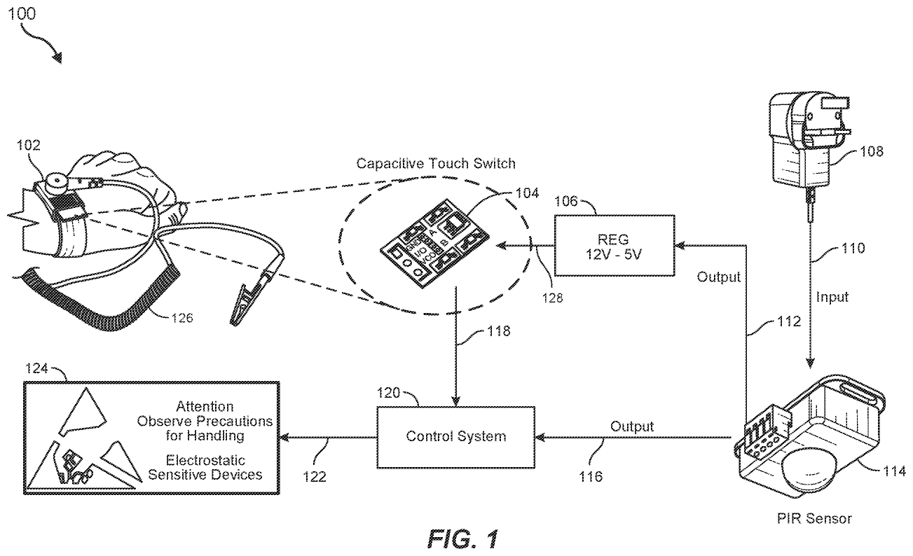

FIG. 1 is a block diagram of an electrostatic discharge (ESD) control device alert system 100 according to one non-limiting embodiment.

As one example, an ESD control wrist strap 102 should be worn while sitting at an electronics work bench. The wrist strap 102 has conductive material that is responsible for grounding any static electricity that builds up on the person wearing the wristband. The conductive material is typically made of metal, such as stainless steel or copper, woven into the fabric of the wrist strap 102. When the ESD wrist strap 102 is worn, the conductive material creates a direct path for static electricity to flow from the body to the ground. For an ESD control wrist strap 102 to work, it is either connected to earth bonding points fitted into work benches or workstations or has a removable coiled grounding wire 126 and crocodile clip for grounding, as shown in FIG. 1.

The ESD control wrist strap 102 also includes a capacitive touch switch 104 attached to an inner surface of the wrist strap 102 that comes into contact with the person's skin wearing the wrist strap 102. For example the capacitive touch switch 104 may be glued, stitched, sewn, snapped on, attached via a magnet, or otherwise attached or affixed to the ESD control wrist strap 102. Other types of switches may be used in various embodiments that are activated in response to a person wearing an ESD control device (e.g., the ESD control wrist strap 102), including, but not limited to: pressure sensitive switches, piezoelectric switches, mechanical switches, button switches, etc.

In the example embodiment shown, the system is powered by a 12V power supply 108 providing power input to a passive infrared (PIR) sensor 114 via input cable 110. A PIR sensor is an electronic sensor that measures infrared light radiating from objects in its field of view. The PIR sensor 114 detects a person entering an area designated for ESD control. For example, the PIR sensor 114 may be positioned in an ESD sensitive area designated for ESD control in a manner such that a person entering the area designated for ESD control comes within the field of view of the PIR sensor 114 and causes the PIR sensor 114 to detect the person entering the area designated for ESD control.

In the present example embodiment, the PIR sensor 114 will not output the power received from the power supply 108 to the other components of the system 100 until it detects a person entering the area designated for ESD control. Thus, the alert 124 will not be activated (e.g., a precaution sign will not be illuminated) unless and until the PIR sensor 114 detects a person entering the area designated for ESD control. In response to the PIR sensor 114 to detecting a person entering the area designated for ESD control, the PIR sensor 114 will output the power received from the power supply 108 to the other components of the system 100 on power output cable 116 and power output cable 112.

In the present example embodiment, the capacitive touch switch 104 receives power from the 12V power supply 108 via the PIR sensor 114 and a 12V to 5V regulator 106 on low voltage wire 128 because the 12V power supply 108 outputs 12V to power the PIR sensor 114 which operates at 12V. However, in other embodiments, the PIR sensor 114 may operate at 5V (or the same voltage as the capacitive touch switch 104) so a regulator may not be required in such embodiments.

A control system 120 (e.g., an light emitting diode (LED) control circuit) also receives power on power output cable 116 from the 12V power supply 108 via the PIR sensor 114. The control system 120 sends an electrical current or signal on cable 122 to activate an alert 124, such as a signal to turn on LEDs that illuminate an ESD precaution sign in response to receiving an input on control signal wire 118 from the capacitive touch switch 104 indicating a person is wearing the ESD control device. An absence of such a signal deactivates the alert 124 (e.g., turns off the LEDs that illuminate the ESD precaution sign by breaking the electrical circuit providing electrical current to the LEDs). Thus, in response to the PIR sensor 114 at the work bench detecting a person entering the area designated for ESD control, the PIR sensor 114 will output the power received from the power supply 108 to the capacitive touch switch 104 and to the control system 120 to activate such components.

The capacitive touch switch 104 then sends a signal on control signal wire 118 to the control system 120 indicating whether a person is wearing the ESD control device. In response to the control system 120 receiving a signal indicating the person is not wearing the ESD control device, the control system 120 determines to not send an electrical signal (e.g., electrical current or power signal) to activate the alert 124. In response to the control system 120 receiving a signal indicating the person is wearing the ESD control device, the control system 120 determines to send an electrical signal (e.g., electrical current or power signal) to activate the alert 124.

The PIR sensor 114 may then detect that there is no longer a person in the area designated for ESD control (e.g., when the person leaves the area designated for ESD control). In response to detecting that there is no longer a person in the area designated for ESD control, the PIR sensor 114 stops delivering power on cable 116 to the control system 120 and thereby causes the power to the alert 124 to be stopped and the alert 124 to be deactivated.

Thus, in the present example embodiment, since the alert 124 is only activated when receiving power from the control system 120 to do so, the alert 124 will be activated by the control system 120 only when a person is detected in the area designated for ESD control (which results in the control system 120 receiving power) and the person is not wearing the ESD control wrist strap 102 as detected by the capacitive touch switch 104.

In various other embodiments, the capacitive touch switch 104 and control system 120 may receive constant power from other sources (e.g., battery power or other power sources). In such embodiments (or other alternative embodiments), the control system 120 may implement a circuit or logic (e.g., utilizing a microcontroller, integrated circuit or microprocessor) that receives as input a signal from the PIR sensor 114 that indicates whether a person is detected in the area designated for ESD control and also receives as input a signal from the capacitive touch switch 104 indicating whether a person is wearing the ESD control wrist strap 102. The control system 120 then determines to send a control signal (e.g., on cable 122) to activate the alert 124 in response the signal from the PIR sensor 114 being received indicating a person is detected in the area designated for ESD control and the signal being received from the capacitive touch switch 104 also at the same time indicating a person is not wearing the ESD control wrist strap 102. When the signal from the PIR sensor 114 indicates a person is not detected in the area designated for ESD control, the control system 120 then determines to not send a control signal to activate the alert 124. In embodiments in which the control system 120 is implemented using an utilizing a microcontroller, integrated circuit or microprocessor, a memory or other non-transitory computer readable storage medium may be coupled to microcontroller, integrated circuit or microprocessor that has instructions stored thereon which, when executed by the microcontroller, integrated circuit or microprocessor, cause the control system 120 to perform the operations described herein.

In such embodiments where the capacitive touch sensor, control system 120, PIR sensor 114 and/or system providing the alert 124 are battery operated (or in other alternative embodiments), wireless operation of such devices may be enabled in embodiments where the capacitive touch sensor, control system 120, PIR sensor 114 and/or system providing the alert 124 have capability to wirelessly communicate with each other and/or with a server, gateway or communication hub. For example, such wireless communication may be via short-range or other wireless technology that uses radio frequencies to share data over a short or longer distances (e.g., Bluetooth, Wi-Fi, NearLink, near-field communication (NFC), low-power wide area network (LPWAN), ultra-wideband (UWB) and IEEE 802.15. 4 communications). In such embodiments, such wireless capability may, for example, be implemented by the capacitive touch sensor, control system 120, PIR sensor 114 and/or system providing the alert 124 by utilizing chips including radio frequency (RF) metal-oxide-semiconductor (CMOS), which is integrated circuit technology that integrates RF, analog and digital electronics on a mixed-signal CMOS RF circuit chip.

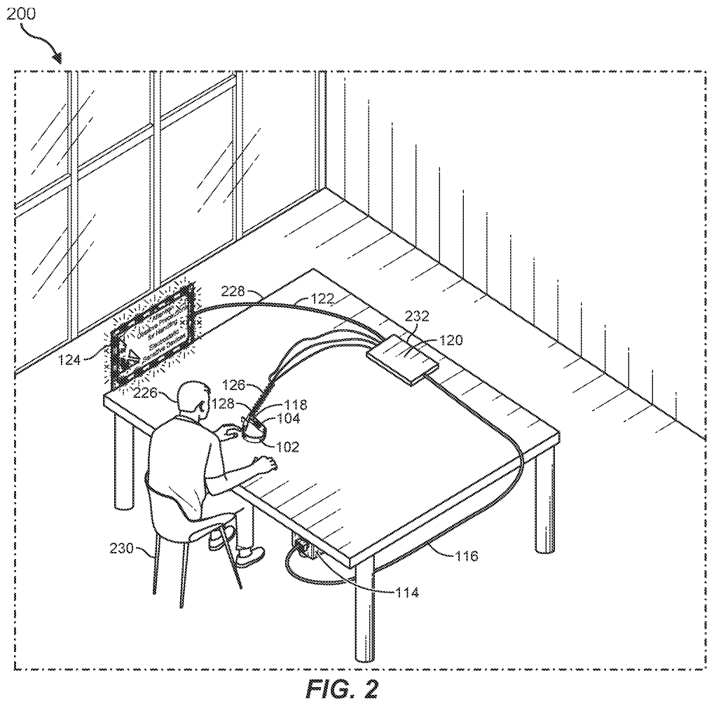

FIG. 2 is perspective view of a room (e.g., an electronics testing lab) showing a first scenario 200 in which a person 226 is sitting at an electronics work bench 228 and the ESD control device alert system 100 of FIG. 1 has activated an alert 124, according to one non-limiting embodiment.

For example, the PIR sensor 114 may be positioned underneath an electronics hardware laboratory work bench 228 (or at a another location at the work bench 228) in a manner such that a person 226 sitting at or in close proximity to the work bench 228 comes within the field of view of the PIR sensor 114 and causes the PIR sensor 114 to detect the person 226 sitting at or in close proximity to the work bench 228.

The wrist strap 102 may be connected by a low voltage wire 128 to the PIR sensor 114 (e.g., through or along a housing 232 of the control system 120) to receive power from the PIR sensor 114. In the example embodiment shown in FIG. 2, the PIR sensor 114 receives power form a power supply such as the power supply 108 shown in FIG. 1 (not shown) and the power output cable 116 from the PIR sensor 114 comprises two separate power cables (or is split inside the housing 232 of the control system 120 into two separate power cables), with one providing power to the control system 120 itself and one providing power to a power output connection on the control system housing 232 for the low voltage wire 128 leading to the capacitive touch switch. As shown in FIG. 1, in some embodiments the low voltage wire 128 from the wrist strap 102 may instead connect to a regulator 106 if needed to convert the voltage received from the PIR sensor 114 if the voltage of the capacitive touch switch is different than that of the PIR sensor 114. In such instances, in the example embodiment shown in FIG. 2, the regulator may be located inside the housing 232 of the control system. The wrist strap 102 is also connected to the control system 120 by another control signal wire 118 to send a control signal to the control system 120 indicating whether the person 226 is wearing the wrist strap 102. The wrist strap 102 also has a grounding wire 126 which may be connected to a grounding source via a crocodile clip or bonding plug in conjunction with a ground lead. Such a connection to a grounding source may be integrated with or on the control system housing 232 or other grounding source on or around the work bench 228.

In an example embodiment shown, the low voltage wire 128 and the control signal wire 118 from the wrist strap 102 go through a coil of the coiled grounding wire 126 of the wrist strap 102, with the control signal wire 118 connected to an input of the control system 120 (e.g., connected to a earth bonding point fitted into the housing of the control system 120). The low voltage wire 128 is connected directly to a power output of the PIR sensor 114 (as shown in FIG. 1) or indirectly, as shown in FIG. 2, to the power output of the PIR sensor 114 through a connection on the housing 232 of the control system 120 that leads to the power output of the PIR sensor 114. The grounding wire 126 is connected to a grounding source on or near the housing 232 of the control system 120.

In the present example embodiment, the PIR sensor 114 will not output the power received from the power supply 108 to the other components of the system 100 until it detects a person 226 sitting at or in close proximity to the work bench 228. In response to the PIR sensor 114 detecting a person 226 sitting at or in close proximity to the work bench 228, the PIR sensor 114 will output the power received from the power supply 108 to the other components of the system 100, including the control system 120. Thus, the precaution sign providing the alert 124 will not be illuminated unless and until the PIR sensor 114 detects a person 226 sitting at or in close proximity to the work bench 228 and the control system 120 receives a signal from the capacitive touch sensor 104 on wrist strap 102 that it is not being worn by the person 226. In various embodiments, the alert 124 may be provided by one or more other techniques including, but not limited to: a digital sign, an electronic message, a text message, an audible alarm, an announcement, a mobile device, a device screen, a computer, a speaker, a remote alarm or notification system, another communication system, etc.

In the present example shown in FIG. 2, the person 226 is detected by the PIR sensor 114 to be at the work bench 228, which results in the control system 120 and capacitive touch switch 104 on the wrist strap 102 receiving power. However, the person 226 is not wearing the ESD control wrist strap 102 as detected by the capacitive touch switch 104 on the wrist strap 102. This causes the control system 120 to output power on the low voltage wire 122 to illuminate the LEDs on the precaution sign.

When the PIR sensor 114 detects the person 226 leaves the work bench 228, the power to the control system 120 will be cut by the PIR sensor 114, thereby causing the power provided by the control system 120 to the LEDs illuminating the precaution sign providing the alert 124 to be cut and turning off the LEDs.

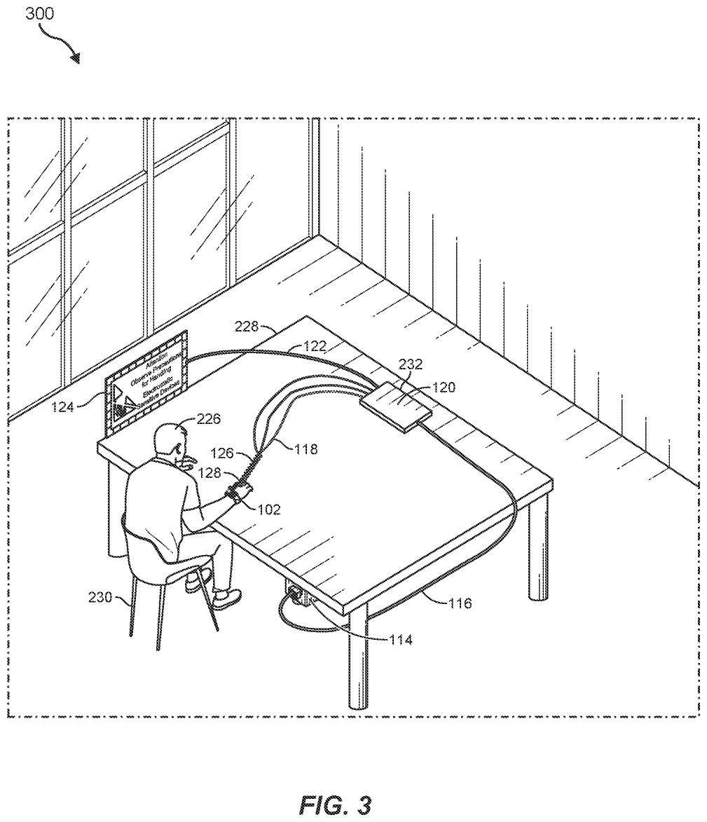

FIG. 3 is perspective view of the room of FIG. 1 showing a second scenario 300 in which the person 226 is sitting at the electronics work bench 228 of FIG. 2 and the ESD control device alert system 100 of FIG. 1 has deactivated an alert 124, according to one non-limiting embodiment.

When the person 226 sitting at the work bench 228 puts on the wrist strap 102 as shown in FIG. 3, this will cause the capacitive touch switch 104 on the inner surface of the wrist strap 102 to come in contact with the person's skin, thereby causing the capacitive touch switch 104 to send a signal to the control system 120 indicating the person 226 is wearing the wrist strap 102. In response, the control system 120 will cut the power currently being provided by the control system 120 to the LEDs that illuminate the precaution sign that provides the alert, thus turning off the LEDs.

In various embodiments, the system 100 may be implemented with different EDS control devices that have touch capacitive switches attached to them that come into contact with the person's skin when the devices are worn such that the system may provide an alert 124 when the person 226 is detected to be at or near the work bench 228 without wearing the ESD control device. Such other devices may include, but are not limited to: an ESD control glove, an ESD control garment, ESD control clothing, ESD control footwear, or an ESD control slipper. For example, ESD control footwear may have a capacitive touch switch 104 attached thereto that comes into contact with the person's skin when worn on their foot. Such a capacitive touch switch 104 attached to ESD footwear may be battery operated (e.g., using a coin cell battery also attached in the footwear) and have a wireless connection to the control system 120 to perform the operations described herein. This may be in addition to or instead of using such capacitive touch switches in other ESD control devices in a manner such as described herein.

In an example embodiment, the system 100 may activate a remote alert 124 in a different room or other area remote from the area designated for ESD control. For example, this may be performed by the control system 120 sending a signal to a computer server via a computer network connection that may generate an alert 124 on a computer or device screen or via another wired or wireless connection to a remote sign or digital alert system in a different room or other location.

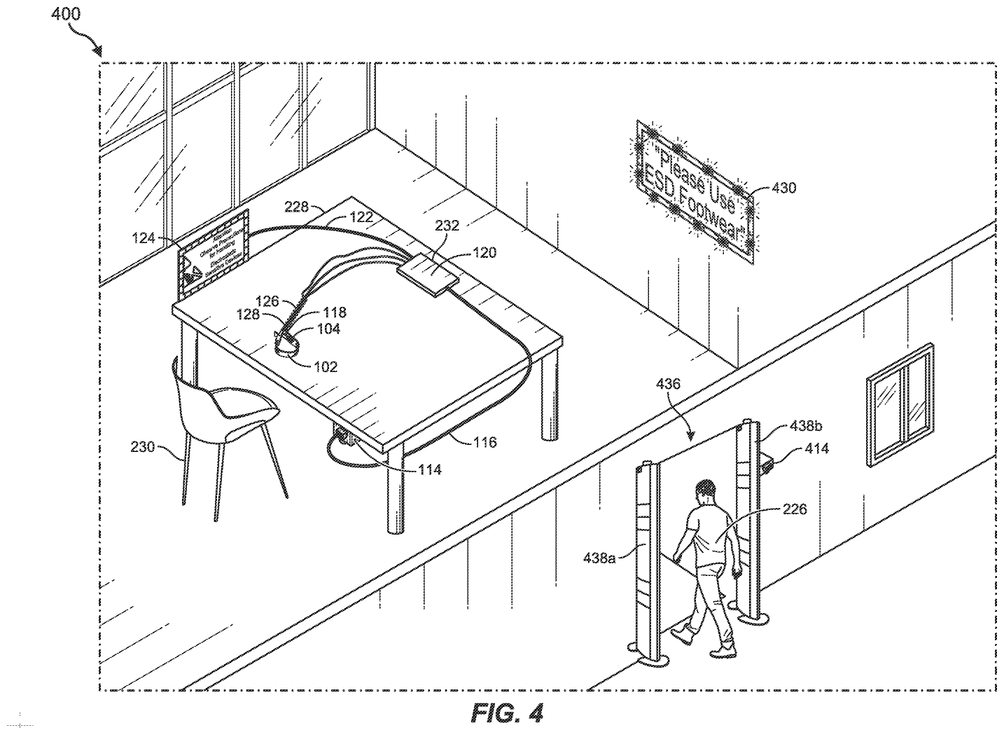

FIG. 4 is top perspective view of the room of FIG. 2 showing a scenario 400 in which the person 226 is entering the room (which is an area designated for ESD control) and in which an ESD control device alert system has activated an alert 430, according to one non-limiting embodiment.

In the example shown in FIG. 4, RFID tags on the dress and footwear can be detected at the entrance of the room in which the work bench 228 is located (e.g., an electronics testing lab) or other ESD sensitive area to remind the person 226 entering to take appropriate measures or to alarm the facility in charge about the same.

For example, an RFID reader gate 436 may be located at the entrance to the room in which the work bench 228 is located. The RFID reader gate 436 may include two vertical RFID gate members, such as gate member 438a and gate member 438b to read an RFID tag passing between gate member 438a and gate member 438b. A wired or wireless control signal connection may be present between the RFID reader gate 436 and the control system 120 or another control system. There may also be a power connection and/or a wired or wireless control signal connection between the control system 120 (or other control system with which the RFID reader gate 436 is in communication) and the sign providing the alert 430 to control power to illuminate the sign providing the alert 430 and/or between the control system 120 an a remote alert system or server.

A person 226 may be detected entering the room in which the work bench 228 is located, such as by a PIR sensor 414 or other motion detector positioned on the RFID reader gate 436 or at or near the entrance to the room. The PIR sensor 414 may be communicatively coupled to the RFID reader gate 436 such that, in response to the PIR sensor 414 detecting the person 226 entering the room, the RFID reader gate 436 will read an RFID tag embedded in or otherwise attached to an ESD control device (e.g., ESD slipper or other ESD footwear) being worn by or being carried by the person 226 passing through the RFID reader gate 436.

In an example embodiment, in order to detect whether the person 226 is actually wearing the ESD device and not just carrying it into the room, an RFID reader device in the RFID reader gate 436 may be positioned in an area in proximity to the area on the person 226 on which the ESD control device is to be worn to receive an RFID signal from the RFID tag. The RFID reader in the RFID reader gate 436 may be set to have a maximum range to cover substantially no more than the area in proximity to the area on the person 226 on which the ESD control device is to be worn as the person 226 enters the room.

If the RFID reader gate 436 is able to read the RFID tag as the person 226 enters through the RFID reader gate 436 and thus detects the person 226 is wearing the ESD control device, then the RFID reader gate 436 may determine to not send a control signal to the control system 120 to illuminate the sign providing the alert 430 or generate another alert 124 remotely to remind the person 226 to wear the ESD device.

However, as shown in the example of FIG. 4, the person 226 walking through the RFID reader gate does not have any ESD control device with an RFID tag and thus the RFID reader gate 436 is not able to read the RFID tag as the person 226 enters through the RFID reader gate 436. In response, the RFID reader gate 436 sends a control signal (e.g., wirelessly) to the control system 120 to activate an alert 430 (e.g., illuminate the sign on the wall coupled to the control system 120) to remind the person 226 entering to take appropriate measures and/or to activate another remote alert to alarm the facility in charge regarding the person 226 entering without the ESD control device. In some embodiments, an RFID reader device may also or instead be located at or near the person's feet when at the work bench 228 (such as below an ESD floor mat) to detect an RFID tag in footwear being worn by the person 226 and proceed as above based on whether an RFID tag is able to be read by the RFID reader.

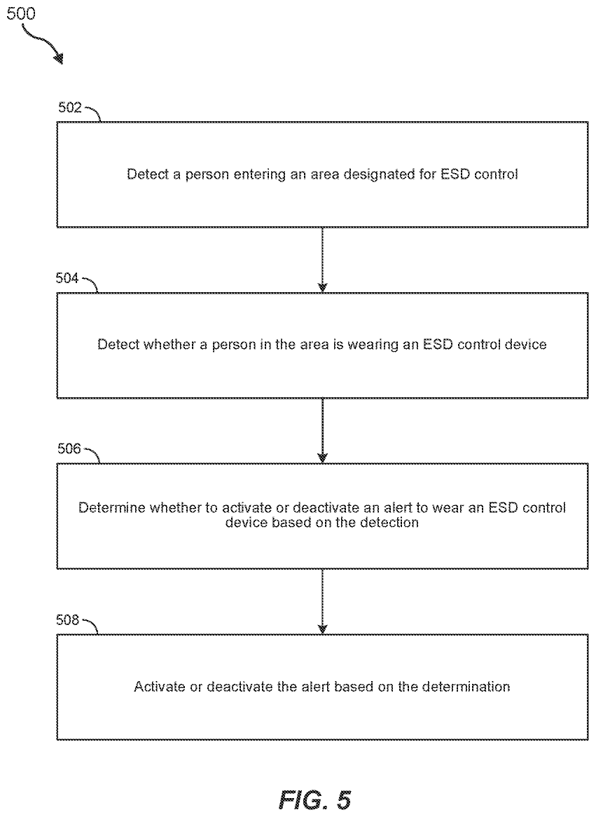

FIG. 5 is a flow diagram of an example method 500 in an ESD control device alert system, according to one non-limiting embodiment.

At 502, the system detects, via a first sensor device, a person entering an area designated for ESD control. For example, this may include detecting, via a passive infrared (PIR) sensor or other motion sensor, a person entering an area designated for ESD control.

At 504, the system detects, via a second sensor device, whether a person in the area is wearing an ESD control device. For example, this may include detecting, via a capacitive touch switch attached to the ESD control device, whether a person in the area is wearing the ESD control device. This may occur after or in response to detecting the person is entering the area. The ESD control device may be an ESD control wrist strap, an ESD control glove, an ESD control garment, ESD control clothing, ESD control footwear, or an ESD control slipper, etc.

In an example embodiment, the system detects the person in the area is not wearing an ESD control device. The system then determines to activate the alert to wear an ESD control device in response to the detection the person in the area is not wearing an ESD control device and activates the alert in response to this determination. The system also detects the person in the area is wearing an ESD control device. The system then determines to deactivate the alert to wear an ESD control device in response to the detection the person in the area is wearing an ESD control device and deactivates the alert in response to the determination.

At 506, the system electronically determines whether to activate or deactivate an alert to wear an ESD control device based on the detection whether a person in the area is wearing an ESD control device.

At 508, the system activates or deactivates the alert based on the determination. This may include activating or deactivating a visible and/or audible alert to wear an ESD control device. For example, this may include activating or deactivating a sign visible by a person in the area designated for ESD control that includes a warning or precaution regarding ESD or a warning or precaution regarding wearing an ESD control device. Activating the sign may include illuminating the sign and the deactivating the sign may include stopping illuminating the sign.

In an example embodiment, the area designated for ESD control is an electronics hardware laboratory work bench area or work station area and the PIR sensor is positioned at or near the work bench or work station area (e.g., positioned under the work bench) such that the PIR sensor is able to detect a person at the work bench area or work station area. The sign may be visible by a person in the area designated for ESD control (e.g., is on or at a work bench in the area designated for ESD control). In another example embodiment, activating or deactivating the alert may also or instead include activating or deactivating a remote alert communicated to a location remote from the area designated for ESD control.

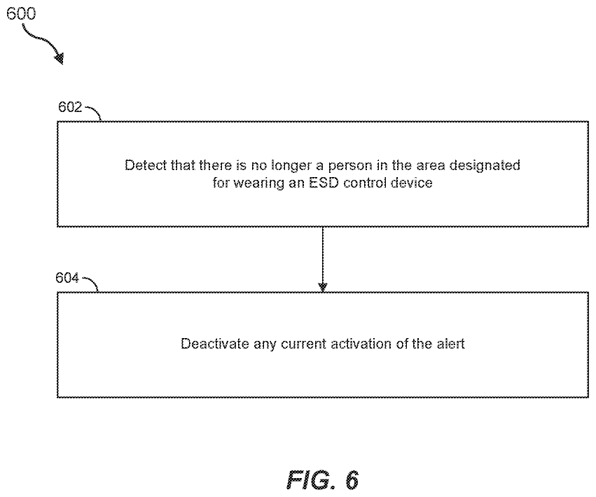

FIG. 6 is a flow diagram of an example method 600 in an ESD control device alert system for when there is no longer a person detected in the ESD control area, according to one non-limiting embodiment.

At 602, the system detects, via the first sensor, that there is no longer a person in the area designated for ESD control.

At 604, in response to detecting that there is no longer a person in the area designated for ESD control, the system deactivates any current activation of the alert by deactivating operation of the first sensor that detects a person entering an area designated for ESD control.

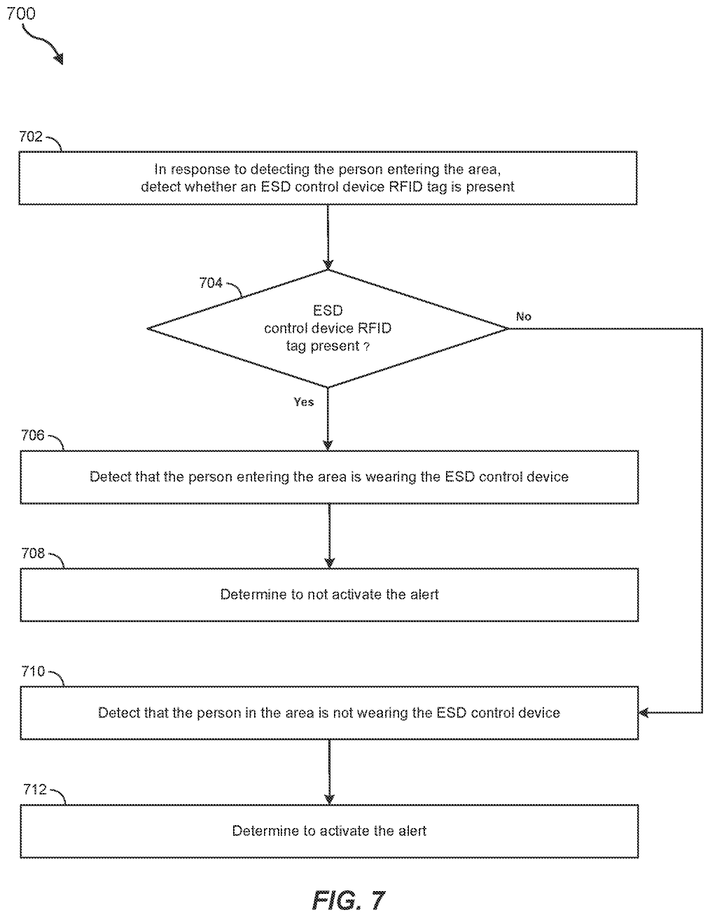

FIG. 7 is a flow diagram of an example method 700 in an ESD control device alert system involving an RFID reader, according to one non-limiting embodiment.

At 702, in response to detecting a person is entering the area designated for ESD control (e.g., an ESD sensitive area), the system detects, via a Radio Frequency Identification (RFID) reader device, whether an ESD control device RFID tag is present on an area on which the ESD control device is to be worn on the person entering the area. In an example embodiment, a sensor device that detects a person is entering the area designated for ESD control (e.g., a PIR sensor) is positioned at an entrance to the area designated for ESD control. The RFID reader device may be positioned in the area designated for ESD control in an area in proximity to the area on which the ESD control device is to be worn on a person entering the area in order to receive and RFID signal from the RFID tag. The RFID reader may be set to have a maximum range to cover substantially no more than the area in proximity to the area on the person on which the ESD control device is to be worn as the person enters the area.

At 704 the systems determines whether the ESD control device RFID tag is present based on the detection. If it is determined that the ESD control device RFID tag is present, then the method 700 proceeds to 706. If it is determined that the ESD control device RFID tag is not present, then the method 700 proceeds to 710.

At 706, in response to detecting the ESD control device RFID tag is present on an area on which the ESD control device is to be worn on the person entering the area, the system detects that the person entering the area is wearing the ESD control device.

At 708, the system determines to not activate the alert.

At 710, in response to detecting the ESD control device RFID tag is not present on an area on which the ESD control device is to be worn on the person entering the area, the system detects that the person entering the area is not wearing the ESD control device.

At 712, the system determines to activate the alert.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in an electrostatic discharge (ESD) control device alert system, the method comprising:
detecting, via a first sensor device, a person entering an area designated for ESD control;
detecting, via a second sensor device, whether a person in the area is wearing an ESD control device;
electronically determining whether to activate or deactivate an alert to wear an ESD control device based on the detection whether a person in the area is wearing an ESD control device; and
activating or deactivating the alert based on the determination.

2. The method of claim 1, wherein:
the detecting whether a person in the area is wearing an ESD control device includes detecting the person in the area is not wearing an ESD control device;
the determining whether to activate or deactivate an alert to wear an ESD control device includes determining to activate the alert to wear an ESD control device in response to the detection the person in the area is not wearing an ESD control device; and
the activating or deactivating the alert based on the determination includes activating the alert in response to the determination.

3. The method of claim 1, wherein:
the detecting whether a person in the area is wearing an ESD control device includes detecting the person in the area is wearing an ESD control device;
the determining whether to activate or deactivate an alert to wear an ESD control device includes determining to deactivate the alert to wear an ESD control device in response to the detection the person in the area is wearing an ESD control device; and
the activating or deactivating the alert based on the determination includes deactivating the alert in response to the determination.

4. The method of claim 1, wherein the detecting, via a first sensor device, a person entering an area designated for ESD control includes:
detecting, via a passive infrared (PIR) sensor, a person entering an area designated for ESD control.

5. The method of claim 4 wherein the area designated for ESD control is an electronics hardware laboratory work bench area or work station area and the PIR sensor is positioned at or near the work bench or work station area such that the PIR sensor is able to detect a person at the work bench area or work station area.

6. The method of claim 4 wherein the area designated for ESD control is an electronics hardware laboratory work bench area the PIR sensor is positioned under a work bench in the work bench area such that the PIR sensor is able to detect a person at the work bench.

7. The method of claim 1 wherein the detecting, via a second sensor device, whether a person in the area is wearing an ESD control device includes:
detecting, via a capacitive touch switch attached to the ESD control device, whether a person in the area is wearing the ESD control device.

8. The method of claim 7 wherein the ESD control device is an ESD control wrist strap, an ESD control glove, an ESD control garment, ESD control clothing, ESD control footwear, or an ESD control slipper.

9. The method of claim 1 wherein the activating or deactivating the alert includes:
activating or deactivating one or more of: a visible and audible alert to wear an ESD control device.

10. The method of claim 1 wherein the activating or deactivating the alert includes:
activating or deactivating a sign visible by a person in the area designated for ESD control that includes a warning or precaution regarding ESD or a warning or precaution regarding wearing an ESD control device.

11. The method of claim 10 wherein the activating the sign includes illuminating the sign and the deactivating the sign includes stopping illuminating the sign.

12. The method of claim 10 wherein the sign visible by a person in the area designated for ESD control is on or at a work bench in the area designated for ESD control.

13. The method of claim 1 wherein the detecting, via a second sensor device, whether a person in the area is wearing an ESD control device occurs after the detecting the person entering the area.

14. The method of claim 1 wherein the detecting, via a second sensor device, whether a person in the area is wearing an ESD control device occurs in response to the detecting the person entering the area.

15. The method of claim 14 wherein the detecting, via a second sensor device, whether a person in the area is wearing an ESD control device includes:
in response to detecting the person entering the area, detecting, via a Radio Frequency Identification (RFID) reader device, whether an ESD control device RFID tag is present on an area on which the ESD control device is to be worn on the person entering the area; and
in response to detecting the ESD control device RFID tag is present on an area on which the ESD control device is to be worn on the person entering the area, detecting, that the person entering the area is wearing the ESD control device.

16. The method of claim 15 wherein:
the first sensor device is positioned at an entrance to the area designated for ESD control;
the RFID reader device is positioned in the area designated for ESD control in an area in proximity to the area on the person on which the ESD control device is to be worn to receive and RFID signal from the RFID tag; and
the RFID reader is set to have a maximum range to cover substantially no more than the area in proximity to the area on the person on which the ESD control device is to be worn as the person entering the area enters the area.

17. The method of claim 14, further comprising:
detecting, via the first sensor, that there is no longer a person in the area designated for ESD control; and
in response to detecting that there is no longer a person in the area designated for ESD control, deactivating any current activation of the alert by deactivating operation of the first sensor that detects a person entering an area designated for ESD control.

18. The method of claim 1 wherein the activating or deactivating the alert includes activating or deactivating a remote alert communicated to a location remote from the area designated for ESD control.

19. An electrostatic discharge (ESD) control device alert system comprising:
a first sensor configured to detect a person entering an area designated for ESD control;
a second sensor configured to detect whether a person in the area is wearing an ESD control device;
a control system coupled to the first sensor and second sensor configured to determine whether to activate or deactivate an alert to wear an ESD control device based on the detection whether a person in the area is wearing an ESD control device; and
an alert system coupled to the control system configured to activate and deactivate the alert in response to input from the control system.

20. The system of claim 19 wherein the second sensor is a capacitive touch switch attached to the ESD control device configured to detect whether a person in the area is wearing the ESD control device, and
further comprising a Radio Frequency Identification (RFID) reader device coupled to the control system configured to detect whether an ESD control device RFID tag is present on an area on the person entering the area on which another ESD control device is to be worn in response to the first sensor detecting the person entering an area designated for ESD control, wherein the control system is further configured to activate another alert in response to the RFID reader device detecting the RFID tag is not present on the area on the person entering the area on which the other ESD control device is to be worn.
